(19) United States
(12) Patent Application Publication
(10) Pub. No.: US 2020/0280858 A1
(43) Pub. Date: Sep. 3, 2020

(54) RADIO ACCESS RESOURCE SHARING

(71) Applicant: Nokia Technologies Oy, Espoo (FI)

(72) Inventor: Zheng YAN, Shaanxi (CN)

(21) Appl. No.: 16/066,270

(22) PCT Filed: Dec. 29, 2015
(86) PCT No.: PCT/FI2015/050948

§ 371 Date: Jun. 26, 2018

(51) Int. Cl. H04W 16/06; H04W 12/10

(52) U.S. Cl. CPC H04W 16/06; H04L 67/10; H04W 12/10

(57) ABSTRACT

According to an example embodiment, a technique for operating a trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided.

### TECHNICAL FIELD

Non-limiting example embodiments of the present invention relate to radio access resource sharing between wireless networks.

### BACKGROUND

The 5th generation mobile networks or 5th generation wireless systems (5G networks) aim to offer a big data bandwidth and virtually infinite capability of networking. The 5G networks are expected to bring improved user experiences on mobile communications and multimedia sharing. In pre-5G networks, a dominant practice to enhance data rate is to increase the number of Base Stations (BSs) and at the same time to go for cells that each cover a smaller respective geographical area in order to increase BS density in the field that, in turn, enables enhanced band reuse factor. However, additional deployment and maintenance of a large number of cellular BSs brings high inefficiencies due to excessive capital and operating expenditures, as well as increased energy consumption. On the other hand, user demography and the demand for network capacity typically vary depending on time of the day and day of the week (the so-called tidal effect). In pre-5G network, each BS's spectral and processing resources are only used by the active users within its cell range, thereby typically causing idle BSs in some areas/times and oversubscribed BSs in others. Moreover, there is no fixed cell size that optimizes the overall coverage and Energy Efficiency (EE) of a cellular network. Another drawback in pre-5G networks is that networking resources and facilities, e.g. BSs, managed and owned by a certain network operator cannot be used by subscribers of another network operator, thereby possibly leaving some of the available network capacity that is under control of a certain network operator unused while another network operator's network capacity in the same area may be insufficient.

To address these e.g. the challenges outlined above, a new centralized architecture based on Software Defined Wireless Network (SDWN) has emerged. In this regard, a Cloud Radio Access Network (C-RAN) is a new architecture for cellular networks where the computational resources of BSs are pooled in a central location. Some key characteristics of the C-RAN may be summarized as follows:
i) centralized management of computing resources;
ii) reconfigurability of spectrum resources;
iii) collaborative communications; and
iv) real-time cloud computing on generic platforms.

As a generic outline, a C-RAN may be considered to consist of the following main elements:
1) One or more Base Band Units (BBU) for carrying out the digital processing tasks related to operating the C-RAN. Each BBU may be provided e.g. by one or more high-speed programmable processors and real-time virtualization technology to provide a respective centralized processing pool for hosting one or more Virtual Base Stations (VBS) that constitute a VBS pool in the respective BBU.
2) For each BBU, one or more Remote Radio Heads (RRHs), each provided with a respective one or more antennas and located at its respective remote site. The one or more RRHs of the BBU are controlled by the VBSs of the respective BBU, thereby providing the radio access via the RRHs.
3) Respective low-latency high-bandwidth optical fibers (or other high-speed data links) for connecting the RRHs to the VBS pool of the respective BBU.

The communication functionalities of the VBSs are typically implemented in software on Virtual Machines (VMs) hosted by one or more server devices (which may be provided e.g. as respective one or more general purpose computing devices) that may be housed in a cloud datacenter. Since in a centralized VBS pool majority (or even all) of the information pertaining to the BSs is available in the same location, the VBSs within the BBU are able to exchange control data and other information at high speeds without stringent bandwidth restrictions, thereby enabling data transfer at Gbps speeds.

### SUMMARY

According to an example embodiment, a method in a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided, the method comprising transmitting a rental request to one or more further trust manager entities concerning a temporary usage of radio access managed by the virtual base station pool served by the respective further trust manager entity, receiving, from one or more further trust manager entities, respective rental offers concerning the temporary usage of radio access managed by the virtual base station pool served by the respective further trust manager, selecting one of the received rental offers in accordance with a predefined selection rule and selecting the source of the selected rental offer as a lending trust manager, transmitting, to the lending trust manager entity, a preliminary request to implement the temporary usage of radio access according to the selected rental offer, wherein the preliminary request comprises a first signature that includes the selected rental offer signed using a private key of the first trust manager entity, and transmitting, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.

According to another example embodiment a method in a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided, the method comprising receiving, from a further trust manager entity, a rental request concerning temporary usage of radio access managed by the virtual base station pool served by the first trust manager entity, generating a rental offer for the further trust manager entity in dependence of the rental request, transmitting the generated rental offer to the further trust manager entity, receiving, from the further trust manager entity, a preliminary request to implement the temporary usage of radio access according to said rental offer, wherein the preliminary request comprises a first signature that includes said rental offer signed using a private key of the further trust manager entity, and transmitting, in response to said preliminary request, to the further trust manager entity, a confirmation that comprises a second signature that includes the first signature signed using a private key of the first trust manager entity.

According to another example embodiment, an apparatus for operating as a first trust manager that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided, the apparatus comprising a communication portion comprising at least one communication apparatus for communication with other apparatuses and a control portion configured to, using the communication portion, cause the apparatus to, transmit a rental request to one or more further trust manager entities concerning a temporary usage of radio access managed by the virtual base station pool served by the respective further trust manager entity, receive, from one or more further trust manager entities, respective rental offers concerning the temporary usage of radio access managed by the virtual base station pool served by the respective further trust manager, select one of the received rental offers in accordance with a predefined selection rule and select the source of the selected rental offer as a lending trust manager, transmit, to the lending trust manager entity, a preliminary request to implement the temporary usage of radio access according to the selected rental offer, wherein the preliminary request comprises a first signature that includes the selected rental offer signed using a private key of the first trust manager entity, and transmit, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.

According to another example embodiment, an apparatus for operating as a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided, the apparatus comprising a communication portion comprising at least one communication apparatus for communication with other apparatuses and a control portion configured to, using the communication portion, cause the apparatus to receive, from a further trust manager entity, a rental request concerning temporary usage of radio access managed by the virtual base station pool served by the first trust manager entity, generate a rental offer for the further trust manager entity in dependence of the rental request, transmit the generated rental offer to the further trust manager entity, receive, from the further trust manager entity, a preliminary request to implement the temporary usage of radio access according to said rental offer, wherein the preliminary request comprises a first signature that includes said rental offer signed using a private key of the further trust manager entity, and transmit, in response to said preliminary request, to the further trust manager entity, a confirmation that comprises a second signature that includes the first signature signed using a private key of the first trust manager entity.

According to another example embodiment, an apparatus for operating as a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network is provided, the apparatus comprising a means for transmitting a rental request to one or more further trust manager entities concerning a temporary usage of radio access managed by the virtual base station pool served by the respective further trust manager entity, means for receiving, from one or more further trust manager entities, respective rental offers concerning the temporary usage of radio access managed by the virtual base station pool served by the respective further trust manager, means for selecting one of the received rental offers in accordance with a predefined selection rule and for selecting the source of the selected rental offer as a lending trust manager, means for transmitting, to the lending trust manager entity, a preliminary request to implement the temporary usage of radio access according to the selected rental offer, wherein the preliminary request comprises a first signature that includes the selected rental offer signed using a private key of the first trust manager entity, and means for transmitting, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.

According to another example embodiment, an apparatus for operating as a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network, the apparatus comprising means for receiving, from a further trust manager entity, a rental request concerning temporary usage of radio access managed by the virtual base station pool served by the first trust manager entity, means for generating a rental offer for the further trust manager entity in dependence of the rental request, means for transmitting the generated rental offer to the further trust manager entity, means for receiving, from the further trust manager entity, a preliminary request to implement the temporary usage of radio access according to said rental offer, wherein the preliminary request comprises a first signature that includes said rental offer signed using a private key of the further trust manager entity, and means for transmitting, in response to said preliminary request, to the further trust manager entity, a confirmation that comprises a second signature that includes the first signature signed using a private key of the first trust manager entity.

According to another example embodiment, a computer program is provided, the computer program comprising computer readable program code configured to cause performing at least the method according to an example embodiment described in the foregoing when said program code is executed on a computing apparatus:

The computer program according to an example embodiment may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to an example embodiment of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some components of a cloud radio access network (C-RAN) according to an example;

FIG. 2 illustrates a block diagram of some components of a trust management arrangement for a C-RAN according to an example embodiment;

FIG. 3 depicts flow diagrams according to an example embodiment;

FIG. 4 depicts a signaling chart according to an example embodiment;

FIG. 5 depicts flow diagrams according to an example embodiment;

FIG. 6 depicts a signaling chart according an example embodiment; and

FIG. 7 illustrates a block diagram of some components of an apparatus according to an example embodiment.

### DESCRIPTION OF SOME EMBODIMENTS

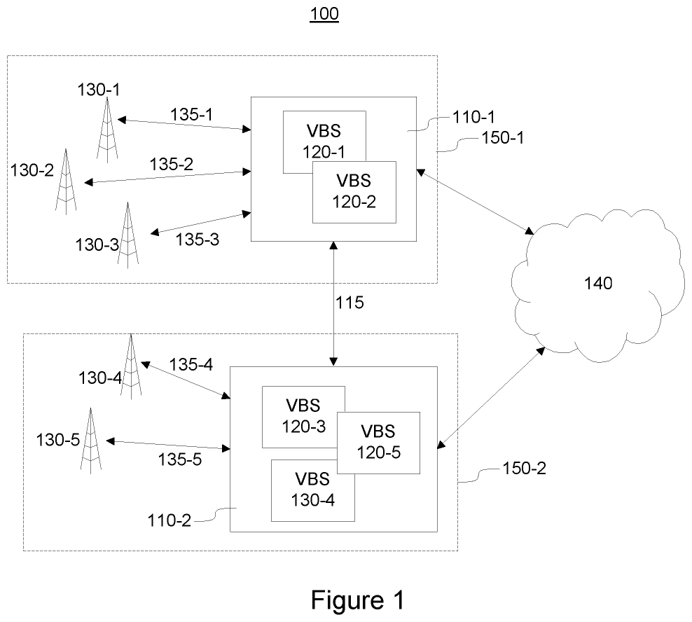

FIG. 1 illustrates a block diagram of some logical components of a C-RAN 100, which serves as a framework for description of various example embodiments. In this regard, the C-RAN 100 is depicted with a first BBU 110-1 and a second BBU 110-2 that represent one or more BBUs 110. In FIG. 1 the first BBU 110-1 and the second BBU 110-2 are connected to each other with a high-speed data link 115. In general, each of the BBUs 110-k may be connected to one or more other BBUs 100 with respective high-speed data links or the BBUs 110 may be connected to each other via a computer network of sufficient data transfer capacity. Each of the BBUs 110-k further coupled to a core network 140 that further connects the BBUs 110 with other C-RANs and/or external networks.

The first BBU 110-1 hosts a first VBS 120-1 and a second VBS 120-2 that represent one or more VBSs 120 hosted by the first BBU 110-1. The C-RAN 100 is further depicted with a first RRH 130-1, a second RRH 130-2 and a third RRH 130-3 that are connected to the VBS pool of the first BBU 110-1 via respective high-speed data links 135-1, 135-2 and 135-3. Hence, the one or more VBSs 120 hosted by the first BBU 110-1 constitute a VBS pool that manages radio access for the first BBU 110-1 via the RRHs 130-1, 130-2 and 130-3 connected thereto. The first BBU 110-1, the VBS pool hosted therein and the RRHs connected thereto via the respective data links may be considered a first BBU subsystem 150-1.

The second BBU 110-2 hosts a third VBS 120-3, a fourth VBS 120-4 and a fifth VBS 120-5 that represent one or more VBSs hosted by the second BBU 110-2. FIG. 1 further depicts a fourth RRH 130-4 and a fifth RRH 130-5 that are connected to the VBS pool of the second BBU 110-2 via respective high-speed data links 135-4 and 135-5. Hence, the one or more VBSs 120 hosted by the second BBU 110-2 constitute a VBS pool that manages radio access for the second BBU 110-2 via the RRHs 130-4 and 130-5 connected thereto. The second BBU 110-2, the VBS pool hosted therein and the RRHs connected thereto via the respective data links may be considered a second BBU subsystem 150-2.

Herein, the BBU subsystems 150-1 and 150-2 represent one or more BBU subsystems 150 of the C-RAN 100. Depending on desired configuration and desired capacity of the C-RAN 100, there may be 1 to K BBU subsystems 150-k. In each BBU subsystem 150-k, there may be 1 to Lₖ VBSs in the VBS pool of the BBU subsystem 110-k and they may have 1 to Mₖ RRHs connected thereto via respective high-speed data links. The high-speed data links 115 and 135-k may be provided, for example, as respective optical fibers.

Typically, all components of a BBU subsystem 150-k are managed, controlled and owned by a single network operator. As an example in this regard, in the example C-RAN 100 both the first BBU subsystem 150-1 and the second BBU subsystem 150-2 may be operated by the same network operator. In another example, the first BBU subsystem 150-1 may be operated by a first network operator and the second BBU subsystem 150-2 may be operated by a second network operator. In general, the K BBU subsystems 150 of the C-RAN 100 may include a plurality of subsets of BBU subsystems 150, each BBU subsystem 150-k operated by a respective network operator.

In such a multi-operator environment in a scenario where the RRHs of two or more network operator's BBU subsystems 150 serve to provide network coverage on at least partially overlapping geographical areas, enhanced co-operation of the BBU subsystems owned by different network operators would enable provision of more economic and more efficient network services. For example, if a first subset of BBU systems 150 that are part of a first network operator's network are operating at or near their full capacity, a second subset of one or more BBU subsystems 150 that are part of a second network operator's network may be employed to provide network services to a subscriber of the first network operator to enable providing the services at a desired or expected quality. Such sharing (or ‘renting’) of network resources across network operators, however, requires trustworthy collaboration between network operators' BBU subsystems to ensure, on one hand, usage of the ‘rented’ network resources in a fair manner and, on the other hand, provision of the network resources to the ‘renting’ network operator at a desired quality of service and cost. Various examples concerning trustworthy collaboration between BBU subsystems 150 are described in the following.

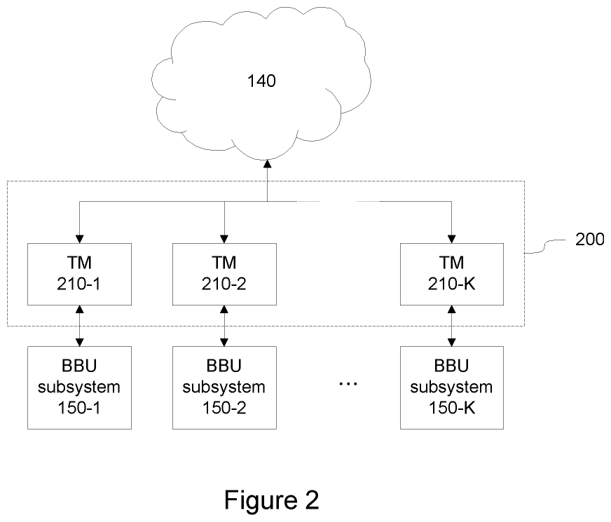

FIG. 2 illustrates a block diagram of some logical components of a trust management arrangement 200 that may be used e.g. in the framework of the C-RAN 100. The trust management arrangement 200 may also be referred to as a trust management pool. In FIG. 2, each of the BBU subsystems 150-1, 150-2, . . . 150-K is provided with a respective trust manager (TM) entity 210-1, 210-2, . . . 210-K, where each TM entity 210-k is arranged to serve the respective BBU subsystem 150-k and/or the VBS pool therein. This, however, is an exemplifying approach described herein for clarity of description, and in a generic case a single TM entity 210-k may serve one or more BBU subsystems 150, typically such that a single TM entity 210-k serves a set of one or more BBU subsystems 150 operated by the same network operator.

While FIG. 2 presents are generic example with K BBU subsystems 150 and K TM entities 210, in various examples the number of BBU subsystems and TM entities may be two or more. The TM entities 210 are connected to each other via a high-speed network or via dedicated high-speed links, and the TM entities 210 are further connected to the core network 140. The BBUs of the BBU subsystems 150 schematically depicted in FIG. 2 are connected to each other and to the core network 140 (as illustrated in FIG. 1) but these connections are not shown in FIG. 2 to facilitate clarity of the illustration.

In operation of the trust management arrangement 200, trust tokens are issued between TM entities 210 to allow trustworthy radio access resource rental and utilization in a generic and secure manner, thereby facilitating balancing of network resources across BBU subsystems 150 operated by different network operators. In an example, a TM entity 210-j serving the BBU subsystem 150-j applies a trust attestation to ensure trustworthy radio access resource sharing with BBU subsystems 150 served by other TM entities 210. As an overview of the operation of the trust management arrangement 200 in case the radio access resources in the BBU subsystem 150-j are found temporarily insufficient, the TM entity 210-j serving the BBU subsystem 150-j may contact one or more other TM entities 210 by transmitting a rental request. Although at this point the TM entity 210-j is sending queries concerning possible rental of radio access resources, for clarity of description it is referred to as a renting TM entity 210-j. Each of the contacted other TM entities 210-k evaluates the rental request and responds with a respective rental offer in case suitable radio access resources are available in the respective BBU subsystem 150-k. Providing the rental offer may be further conditional on the rental request being compatible with a the rental policy applied by the TM entity 210-k. Compatibility with the rental policy may involve, for example, consideration of one or more of the following aspects:

the extent of availability of currently unused radio access resources in the BBU subsystem 150-k,
relative priority of the resource rental assigned for the renting TM entity 210-j,
existence and/or type of a predefined rental agreement between the TM entity 210-k and the renting TM entity 210-j,
duration of a time period for which the radio access resources are requested, and
expected radio access resource usage during the requested rental.

The renting TM entity 210-j may receive respective rental offers from one or more other TM entities 210 and select one of the rental offers in view of a rental decision policy applied by the TM entity 210-j. The rental decision policy may consider, for example, estimated cost of the offered radio access resources and/or respective reputations of the underlying network operator for each of the received rental offers in making the selection of zero or one rental offers. In case one of the rental offers is selected by the TM entity 210-j, the network operator that is in control of the BBU subsystem 150-k served by the TM entity 210-k whose offers was selected is designated as a lending network operator, whereas the network operator that is in control of the BBU subsystem 150-j served by the renting TM entity 210-j is designated as a renting network operator. Along similar lines, the BBU subsystem 150-k may be referred to as the lending BBU subsystem 150-k, the TM entity 210-k may be referred to as the lending TM entity 210-k, and the BBU subsystem 150-j may be referred to as the renting BBU subsystem 150-j.

In response to selecting the rental offer from the lending TM entity 210-k, the lending BBU subsystem 150-k is assigned to provide the radio access resources, according to the selected rental offer, for one or more subscribers of the renting network operator instead of the renting BBU subsystem 150-j. During the rental, e.g. the rental time and the radio access resources consumed by the one or more subscribers of the renting network operator are logged by the lending TM entity 210-k. The logged pieces of information are reported to the renting TM entity 210-j by using a trust attestation, trust monitoring and trust assurance in the lending TM entity 210-k based on a rental policy of the renting TM entity 210-j. After the rental, a trust token is generated by the lending TM entity 210-k based on the information logged during the rental, which trust token is signed by both the lending TM entity 210-k (on behalf of the lending network operator) and the renting TM entity 210-j (on behalf of the renting network operator). The trust token may be, subsequently, applied by the lending network operator to claim the cost associated with the rental from the renting network operator.

Upon initialization or reconfiguration (e.g. at the time of installation or after a maintenance operation) of the C-RAN, each of the TM entities 210-j attests an execution environment of the VBS pool in the BBU 110-j in the BBU subsystem 150-j it is serving. Attestation of the execution environment involves verification that the BBU 110-j runs correct software, employs a standard hardware and/or employs a standard virtual machine. This procedure where the TM entity 210-j verifies the integrity of the BBU-j 110-j it serves may be referred to as a self-attestation procedure.

Moreover, when in operation, each of the TM entities 210-j may be arranged to periodically repeat the self-attestation procedure in order to ensure that, especially, the software in the BBU 110-j continues to be correct, thereby verifying that no unexpected and undesired software change due to e.g. intrusion or hardware malfunction has taken place. The periodic repetition may be take place at predefined fixed time intervals. The duration of the predefined time interval may be selected in accordance with the desired level of security, e.g. from a range of a few minutes to a few hours. In addition to or instead of periodic repetition, the self-attestation procedure within the TM entity 210-j may be carried out in response to an occurrence of a predefined event and/or in response to receiving an explicit command or request e.g. via/from a control system of the BBU subsystem 150-j. As an example, the control system may be arranged to issue such a command/request in response to an upgrade or other controlled change in the software and/or hardware in the BBU 110-j.

In an example, the self-attestation procedure comprises the TM entity 210-j requesting the BBU 110-j to provide a hash code (or a chain of two or more hash codes) of the software, the hardware and the virtual machine in the BBU 110-j using a predefined hash function. In the following, for editorial clarity of description, the entities of the BBU 110-j (or any another entity of the trust management arrangement 200) considered in the hash code computation are jointly referred to as the execution environment of the BBU-j (or of the other entity of the trust management arrangement 200). In response to this request, the BBU 110-j may compute the hash code accordingly and transmit it to the TM entity 210-j. The BBU 110-j may further store the computed hash code in a memory therein for subsequent use. The TM entity 210-j may also store the received hash code in a memory therein. The TM entity 210-j may compare the received hash code to a reference hash code: if the received hash code matches the reference hash code, the self-attestation is successful, whereas in case the received hash code does not match the reference hash code, the self-attestation fails. The reference hash code may be received from a trusted third party together with a certification (e.g. with a digital certificate that serves to ensure authenticity of the reference hash code).

Herein (as well as in context of subsequent references to computing a hash code), the hash code of the execution environment may be computed using any suitable technique known in the art. As an illustrative example in this regard, a hash code of a software component or a software package may be computed by using the predefined hash function to compute the hash code of a binary code that constitutes the software component or to compute the hash code of a binary code that constitutes the software package. As another illustrative example in this regard, a hash code of a hardware component may be computed by using the predefined hash function to compute the hash code of a binary code embedded in the hardware component or in a certain configuration of hardware components or to compute the hash code of a basic input/output system (BIOS) of the hardware component or the combination of hardware components.

Consequently, the self-attestation procedure may be employed to reveal any unexpected change in the execution environment of the BBU 110-j. The result of each self-attestation procedure may be stored in the memory within the TM entity 210-j for further reference and/or for subsequent verification. Additionally or alternatively, the result of the attestation procedure may be reported to one or more other entities, e.g. to one or more other TM entities 210 and/or to a control system of the BBU subsystem 150-j. In response to a successful self-attestation procedure, the TM entity 210-j proceeds to operate or continues to operate as part of the trust management arrangement 200. In response to an unsuccessful self-attestation procedure, the TM entity 210-j may issue an alarm or indication regarding the failed self-attestation and/or the TM entity 210-j may refrain from operating as part of the trust management arrangement 200.

In order to ensure trusted collaboration between BBU subsystems 150, the TM entity 210-j may carry out a trust attestation (TA) procedure with one or more other TM entities 210-j of the trust management arrangement 200. As an example, the TM entity 210-j may be arranged to carry out the TA procedure with the TM entity 210-k periodically, e.g. at predefined time intervals. The duration of the predefined time interval may be selected in accordance with the desired level of security, e.g. from a range of a few minutes to a few hours As another example, the TM entity 210-j may be arranged to carry out the TA procedure with the TM entity 210-k in response to an occurrence of a predefined event, e.g. in response to detecting a need for radio access resources from another operator's network. In a further example, the TM entity 210-j may be arranged to carry out the TA procedure with the TM entity 210-k in response to receiving an explicit command or request e.g. via/from a control system of the BBU subsystem 150-j to carry out the TA procedure.

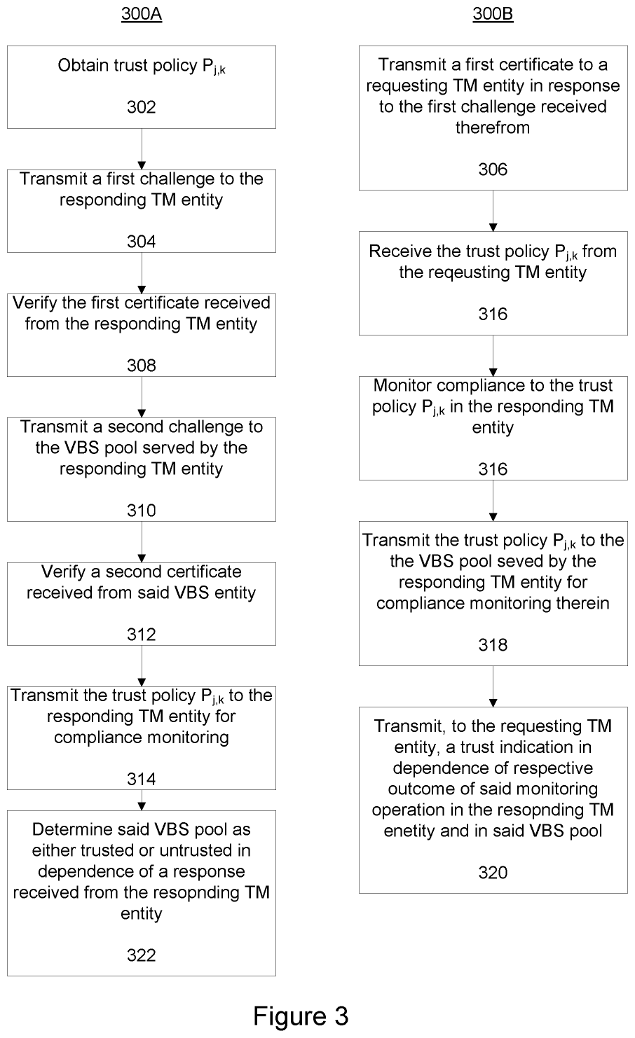

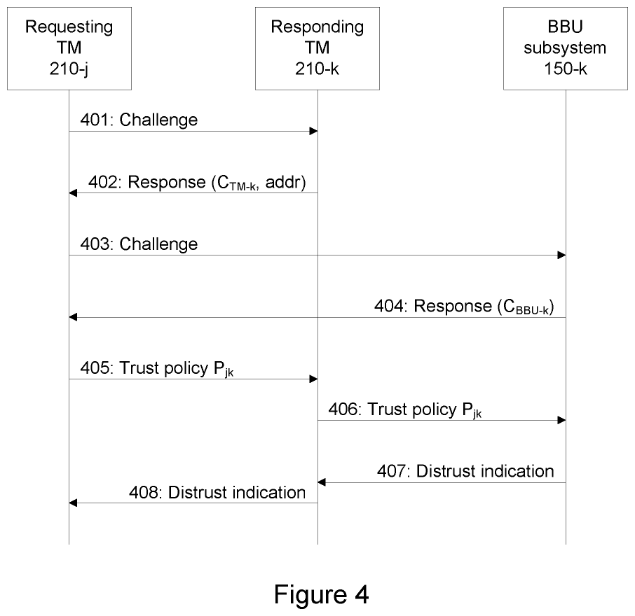

FIG. 3 depicts respective flow diagrams that outline methods 300A and 300B for carrying out the TA procedure between two TM entities 210-j and 210-k according an example, whereas FIG. 4 depicts a signaling chart that outlines the TA procedure between the two TM entities 210-j and 210-k according an example. Note that for this example the terms renting TM entity and the lending TM entity are not applied since the TA procedure is not necessarily strictly linked to a specific occasion of radio access resource rental between two network operators but rather serves as a pre-assurance regarding the BBU subsystem 150-k served by the TM entity 210-k being able to lend radio access resources in according to a policy of the TM entity 210-j. Therefore, for clarity of description, in context of the TA procedure we refer to the TM entity 210-j as a requesting TM entity 210-j and to the TM entity 210-k as a responding TM entity 210-k. In the following, the exemplifying TA procedure between the requesting TM entity 210-j and the responding TM entity 210-k is described with references to FIGS. 3 and 4.

The TA procedure involves the requesting TM entity 210-j obtaining its trust policy pertaining to the network operator of the BBU subsystem 150-k, as indicated in block 310. In the following, this trust policy is denoted as Pⱼₖ. Obtaining the trust policy Pⱼₖ may involve reading a pre-created trust policy from a memory or a mass storage device within the requesting TM entity 210-j or generating the trust policy Pⱼₖ for the present occasion of the TA procedure with the responding TM entity 210-k. The trust policy Pⱼₖ includes a set of one or more reference hash codes that are obtained, for example, from a trusted third party. The trust policy Pⱼₖ may further include a public key of a certificate issuer (e.g. a trusted third party) for certificate verification purposes. The trust policy Pⱼₖ may possibly also include one or more policy rules for handling subsequent changes in the responding BBU 110-k. Such policy rules may require the responding BBU 110-k (or the responding TM entity 210-k) to carry out e.g. one or more of the following:
reject any upgrade or other change of execution environment in the responding BBU 110-k during radio access rental by the renting network operator;
report any (unexpected) subsequent change of the execution environment in the responding BBU 110-k to the requesting TM entity 210-j (which may be detected e.g. via a self-attestation procedure carried out by the responding TM entity 210-k) in order to re-trigger the TA procedure between the requesting TM entity 210-j and the responding TM entity 210-k;

In step 401, the requesting TM entity 210-j transmits a first challenge to the responding TM entity 210-k, as also indicated in block 304. The challenge may include a predefined message or identifier that enables the responding TM entity 210-k to identify it as the first challenge of the TA procedure. In response to receiving the first challenge, the responding TM entity 210-k responds to the first challenge by transmitting a response that includes its execution environment certificate and an indication of the address of the BBU 110-k that hosts the VBS pool for the BBU subsystem 150-k (and/or the address of another appropriate entity in the BBU subsystem 150-k) to the requesting TM entity 210-j, as indicated in block 306 and step 402. This execution environment certificate may be provided as a digital certificate issued by a trusted third party. The certificate may be formatted (for transmission to the requesting TM entity 210-j), for example, according X.509 standard known in the art. Herein, we denote this certificate as a first certificate C_{TM-k}. In an example, the response may, instead of or in addition to the first certificate C_{TM-k}, include the hash code of the execution environment of the responding TM entity 210-k computed using the predefined hash function. The hash code may be obtained by computing the hash code in response to the first challenge or reading the hash code most recently computed in the responding TM entity 210-k from the memory.

In response to receiving the response to the first challenge from the responding TM entity 210-k, the requesting TM entity 210-j carries out verification of the first certificate C_{TM-k} and/or the hash code received in the response. In case the response includes the first certificate C_{TM-k}, a certificate verification in order to ensure validity of the received first certificate C_{TM-k} received in the response is carried out, as indicated block 308. In this regard, any suitable verification procedure known in the art may be employed. In case the response, additionally or alternatively, includes the hash code, the requesting TM entity 210-j further verifies the hash code received from the responding TM entity 210-k. This verification may be carried out in view of the set of reference hash codes defined in the trust policy Pⱼₖ: the hash code verification is successful in case the received hash code matches one of the reference hash codes.

In case any of the applied verifications fails (e.g. if either or both of the certificate verification and the hash code verification fails), the requesting TM entity 210-j terminates the TA procedure and considers the responding TM entity 210-k not to constitute a trusted entity for radio access resource sharing. In case each of the applied verifications is successful, the requesting TM entity 210-j proceeds to step 403 to transmit a second challenge to the address received from the responding TM entity 210-k in step 402, as also indicated in block 310. The challenge may include a predefined message or identifier that enables the responding TM entity 210-k to identify it as the second challenge of the TA procedure.

In step 404, the BBU subsystem 150-k (e.g. the BBU 110-k that hosts the VBS pool for the BBU subsystem 150-k) responds to the second challenge by transmitting a response that includes the execution environment certificate of the VBS pool therein to the requesting TM entity 210-j. As in case of the first certificate C_{TM-k}, this execution environment certificate may be provided as a digital certificate issued by a trusted third party and the certificate may be formatted (for transmission to the requesting TM entity 210-j), for example, according X.509 standard known in the art. Herein, we denote this certificate as a second certificate C_{BBU-k}. In an example, the response may, instead of or in addition to the second certificate C_{BBU-k}, include the hash code of the execution environment of the responding BBU 110-k computed using the predefined hash function. The hash code may be obtained by computing the hash code in response to the second challenge or reading the hash code most recently computed in the responding BBU 110-k from the memory.

In response to receiving the response to the second challenge from the responding BBU 110-k (or from another entity of the BBU subsystem 150-k), the requesting TM entity 210-j carries out verification of the second certificate C_{BBU-k} and/or the hash code received in the response. In case the response includes the second certificate C_{BBU-k}, a certificate verification in order to ensure validity of the received second certificate C_{BBU-k} received in the response is carried out, as indicated in block 312. In this regard, a suitable verification procedure known in the art may be employed. In case the response, additionally or alternatively, includes the hash code, the requesting TM entity 210-j further verifies the hash code received from the responding BBU 110-k. As in case of the hash code received from the responding TM entity 210-k in response to the first challenge, also this verification may be carried out in view of the set of reference hash codes defined in the trust policy Pⱼₖ: the hash code verification is successful in case the received hash code matches one of the reference hash codes.

In case any of the applied verifications fails (e.g. if either or both of the certificate verification and the hash code verification fails), the requesting TM entity 210-j terminates the TA procedure and considers the responding BBU 110-k not to constitute a trusted entity for radio access resource sharing. In case each of the applied verifications is successful, the requesting TM entity 210-j proceeds to step 405 to transmit the trust policy Pⱼₖ to the responding TM entity 210-k, as also indicated block 314.

In response to receiving the trust policy Pⱼₖ (block 316), the responding TM entity 210-k monitors the operation of its execution environment in view of the trust policy Pⱼₖ, as indicated in block 316. In an example, the monitoring involves verifying that hash code of the execution environment of the responding TM entity 210-k computed using the predefined hash function matches one of the reference hash codes defined in the received trust policy Pⱼₖ, and the monitoring may further comprise verification of the certificate of the renting TM entity 210-j (received e.g. from a trusted third party) using a public key that may be included in the trust policy Pⱼₖ and/or verifying that the responding TM entity 210-k is set to operate according to the policy rules that may be defined in the received trust policy Pⱼₖ. The monitoring may be subsequently repeated periodically according to a predefined schedule, e.g. at predefined time intervals where the duration of the predefined time interval may be selected in accordance with the desired level of security, e.g. from a range of a few minutes to a few hours. In an example, instead of using predefined schedule for repetitions of the monitoring, the schedule (e.g. the duration of the time interval) may be defined the in the trust policy Pⱼₖ. In case the monitoring indicates that the responding TM entity 210-k does not operate according to the trust policy Pⱼₖ, the procedure may directly proceed to step 408 for transmission of a distrust indication. In case the monitoring indicates that the responding TM entity 210-k does operate according to the trust policy Pⱼₖ, the responding TM entity 210-k proceeds step 406 that involves forwarding the trust policy Pⱼₖ to the BBU 110-k that hosts the VBS pool for the BBU subsystem 150-k, as also indicated in block 318.

In response to receiving the trust policy Pⱼₖ, the BBU 110-k that hosts the VBS pool for the BBU subsystem 150-k monitors the operation of its execution environment in view of the trust policy Pⱼₖ. In an example, the monitoring involves verifying that hash code of the execution environment of the responding BBU 110-k computed using the predefined hash function matches one of the reference hash codes defined in the received trust policy Pⱼₖ and that the responding BBU 110-k is set to operate according to the policy rules that may be defined in the received trust policy Pⱼₖ. The monitoring may be subsequently repeated periodically according to a predefined schedule, e.g. at predefined time intervals where the duration of the predefined time interval may be selected in accordance with the desired level of security, e.g. from a range of a few minutes to a few hours. In an example, instead of using predefined schedule for repetitions of the monitoring, the schedule (e.g. the duration of the time interval) may be defined the in the trust policy Pⱼₖ.

In case the monitoring indicates that the element of the BBU 110-k does not operate according to the trust policy Pⱼₖ, the BBU 110-k transmits a (first) distrust indication to the responding TM entity 210-k in step 407. In response to receiving the (first) distrust indication from the BBU 110-k, the responding TM entity 210-k transmits in step 408 a (second) distrust indication to the requesting TM entity 210-j as an indication of the responding TM entity 210-k, the BBU subsystem 150-k or both being non-compliant with the trust policy Pⱼₖ. The (second) distrust notice may include respective indications concerning policy-compliance of the responding TM entity 210-k, the BBU subsystem 150-k to provide the requesting TM entity 210-j with an indication concerning the source of non-compliance.

In the TA procedure outlined by steps 401 to 408 only distrust is explicitly indicted to the requesting TM entity 210-j, thereby rendering a lack of an explicit distrust indication as an implicit indication of trusted relationship between the requesting TM entity 210-j and the responding TM entity 210-k for the purpose of the requesting TM entity 210-j renting radio access resources from the responding TM entity 210-k in the framework of the trust management arrangement 200. In a variation of this procedure, also (or only) a positive outcome of the respective trust policy verification in the responding TM entity 210-k and/or the BBU-k 110-k is notified to the other entities using respective trust indications, e.g. by a trust indication transmitted from the responding TM entity 210-k to the requesting TM entity or by a trust indication transmitted from the BBU 110-k to the responding TM entity 210-k that is further forwarded therefrom to the requesting TM entity 210-j.

The requesting TM entity 210-j may carry out the TA procedure with a plurality of other TM entities 210 within the trust management arrangement 200. Consequently, the requesting TM entity 210-j is able to keep track of the other BBU subsystems 150 that provide trusted collaboration in terms of radio access resource sharing in case the radio access resources of the BBU subsystem 150-j served by the requesting TM entity 210-j are temporarily insufficient.

In case the TM entity 210-j obtains an indication concerning temporally insufficient radio access resources in the BBU subsystem 150-j, the TM entity 210-j may initiate a rental negotiation procedure concerning temporary use of radio access resources of another BBU subsystem 150 with one or more other TM entities 210 of the trust management arrangement 200. Further examples of a condition that may trigger the TM entity 210-j to initiate the rental negotiation include a high cost (e.g. higher than a predefined threshold) of currently employed radio access resources and a low quality of service (e.g. lower than a predefined threshold) of currently employed radio access, where the currently employed radio access may be provided as radio access resources rented from another BBU subsystem 150 or radio access resources in the BBU subsystem 150-j.

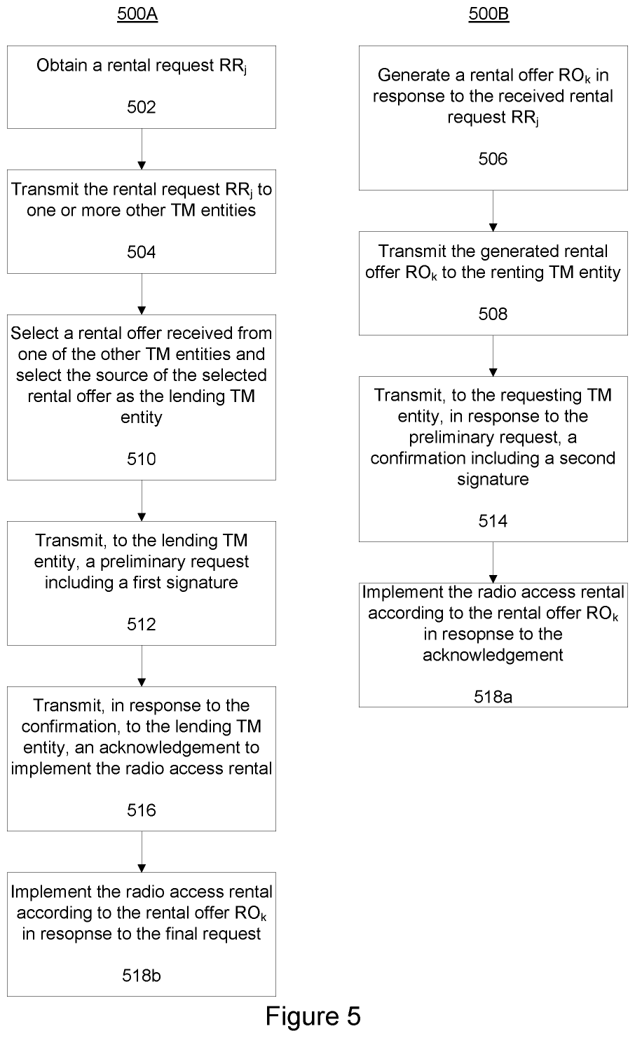

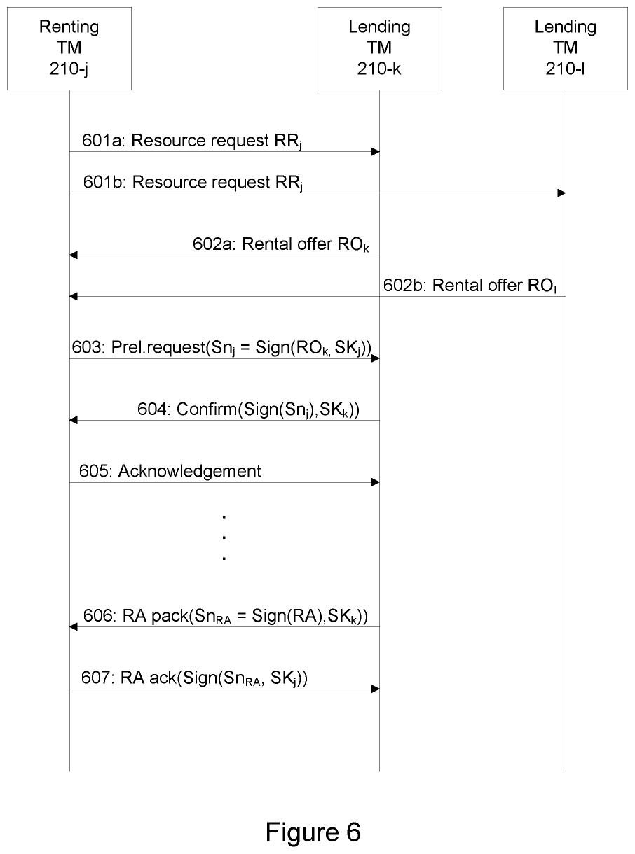

As an example in this regard, FIG. 5 depicts respective flow diagrams that outline methods 500A and 500B for carrying out the rental negotiation between the TM entity 210-j and two other TM entities 210-k and 210-l according to an example, whereas FIG. 6 depicts a signaling chart that outlines this exemplifying rental negotiation procedure. Herein, in FIG. 6 two other TM entities are shown to ensure editorial clarity of the example, while in other examples the TM entity 210-j may carry out the rental negotiation procedure with only a single other TM entity 210-j or with more than two other TM entities 210. In this regard, the rental negotiation procedure is carried out only with such other TM entities 220 with which a trusted relationship has been verified e.g. on basis of the TA procedure described in the foregoing. Herein, for editorial clarity of description we refer to these TM entities as the renting TM entity 210-j and the lending TM entities 210-k, 210-l, although during the rental negotiation procedure the roles of a renting TM entity and a lending TM entity are provisional, to be decided as an outcome of the rental negotiation procedure with zero or more other TM entities 210 of the trust management arrangement 200.

As an initial step, the renting TM entity 210-j obtains or defines a rental request RRⱼ, as indicated in block 502. The rental request RR includes one or more pieces of information that characterize the desired rental of radio access resources. In an example, the rental request RR defines at least amount (or volume) of requested radio access resources rrⱼ (expressed e.g. as a requested bandwidth, as a requested total amount of data transfer via the radio access resources, as a requested flow size, etc.) and time rtⱼ of the requested rental, which may define the starting time and the ending time for the requested rental. In step 601a and 601b, the renting TM entity 210-j transmits the rental request RR to the lending TM entities 210-k and 210-l, respectively, as also indicated in block 504. Transmission of the rental request RR may involve broadcasting the rental request such that it is receivable by all other TM entities 210 of the trust management arrangement 200.

In response to the rental request RRⱼ, the lending TM entity 210-k generates a rental offer ROₖ to the renting TM entity 210-j in dependence of the rental request RR (block 506) and transmits the generated rental offer ROₖ to the renting TM entity 210-j, as indicated in step 602a, and block 508. The rental offer ROₖ may include an indication of a unit price UP_{k,j} associated with the present rental offer ROₖ. The included unit price UP_{k,j} may indicate a pre-agreed unit price between the renting network operator and the lending network operator or it may indicate a unit price that is defined for the present rental offer ROₖ (e.g. in view of amount of unused radio access resources within the lending BBU subsystem 150-k). In case no indication of unit price UP_{k,j} is included in the rental offer ROₖ, a pre-agreed unit price between the lending network operator and the renting network operator may be assumed for the present rental offer ROₖ. Along similar lines, in response to the rental request RRⱼ, the lending TM entity 210-l generates a rental offer ROₗ to the renting TM entity 210-j in dependence of the rental request RR and transmits the generated rental offer ROₗ to the renting TM entity 210-j, as indicated in step 602b.

The generation of the rental offer ROₖ in the lending TM entity 210-k may comprise, for example, consideration of one or more of the following aspects, whereas the lending TM entity 210-l may generate the respective rental offer ROₗ in a similar manner:
amount of unused radio access resources available in the lending BBU 150-k served by the lending TM entity 210-k, denoted as frₖ;
amount of requested radio access resources rrⱼ (as indicated in the received rental request RR);
relative priority assigned for the renting TM entity 210-k (in relation to the priorities assigned for other TM entities 210), denoted as pr_{k,j};
unit price UP_{k,j} for the present rental offer ROₖ, which may be (as described in the foregoing), a pre-agreed unit price between the lending network operator and the renting network operator or a unit price defined for the present rental offer;
estimated need for radio access resources in the lending BBU subsystem 150-k for its own subscribers at the time rtⱼ (as indicated in the received rental request RRⱼ), denoted as erₖ.

The pieces of information discussed above may be applied to generate the rental offer ROₖ in the lending TM entity 210-k e.g. according to following procedure
If the lending TM entity 210-k has a pending resource request RRₙ from another TM entity 210-n for which the relative priority pr_{k,n} is higher than the relative priority pr_{k,j} (i.e. pr_{k,n}>pr_{k,j})
then process the resource request RRₙ before processing the resource request RR from the renting TM entity 210-j;
else if frₖ<rrⱼ
then reject the resource request RR from the renting TM entity 210-j;
else if erₖ+rrⱼ<frₖ
then generate the rental offer ROₖ based on the requested amount of resources rrⱼ and the unit price UP_{k,j} for the present rental offer ROₖ;
else reject the rental request RRⱼ.

In a variation of the above, the lending TM entity 210-k, 210-l may refrain from generating the respective rental offer ROₖ, ROₗ without explicit evaluation of the rental request RR in case the unused radio access resources in the respective BBU subsystem 150-k, 150-l are currently insufficient to justify the rental or are estimated to be insufficient at the time of the rental. In such a scenario, the respective lending TM entity 210-k, 210-l may transmit, to the renting TM entity 210-j, an explicit indication of rental of the radio access resources according to the rental request RR not being possible or it may simply refrain from transmitting the respective rental offer ROₖ, ROₗ to indicate that rental according to the rental request RR is not possible.

When the renting TM entity 210-j has received the rental offers ROₖ and ROₗ from the respective lending TM entities 210-k, 210-l (and/or from any further TM entities 210 to which the renting TM entity 210-j has transmitted the resource request RRⱼ, it compares the received rental offers and selects one of the rental offers ROₖ and ROₗ according to a predefined selection rule, as indicated in block 510. A non-limiting example of a selection rule is described in the following.

In this example, the selection rule is based on trust values assigned for the BBU subsystems 150 (or the network operators operating these BBU subsystems) served by the lending TM entities 210-k and 210-l that have provided the rental offers ROₖ and ROₗ. In this regard, the following equation may be employed to compute a relative trust value TV_{j,k} for the rental offer ROₖ:

$${TV}_{j , k} = α \cdot {T}_{j , k} + β \cdot \frac{1}{N - 1} {\sum }_{x = 1}^{X} ( 1 - \vert {T}_{j , k} - {T}_{x , k} \vert ) \cdot {T}_{x , k} , \qquad ( 1 )$$

where T_{j,k} denotes the trust assigned for the lending TM entity 210-k by the renting TM entity 210-j, T_{x,k} denotes the trust assigned for the lending TM entity 210-k by the TM entity 210-x, and α and β denote, respectively, predefined weighting values applied in the renting TM entity 210-j for the contribution of T_{j,k} and T_{x,k}. Typically, although not necessarily, the weighting values α and β are defined such that α+β=1.

As an example, the variable T_{j,k} of the equation (1) may be computed on basis of past radio access resource rentals from the lending BBU subsystem 150-k by the renting TM entity 210-j, e.g. such that if N_{g} denotes the number of good rental experiences in the past and N_{b} denotes the number of bad rental experiences in the past, the trust T_{j,k} may be computed as T_{j,k}=N_{g}/(N_{g}+N_{b}+1). After each completed rental, one of the indicators N_{g} or N_{b} may be incremented (by one) e.g. based on feedback from the subscribers of the renting network operator and/or on basis of quality of service monitoring applied by the renting network operator, and the trust T_{j,k} may be computed (or updated) and stored in the memory for subsequent use in computation of the relative trust value TV_{j,k}. The computed (or updated) value of the trust T_{j,k} may be further reported to other TM entities 210 of the trust management arrangement 200. The variables T_{x,k} may be computed along similar lines in respective TM entities 210-x and reported to the TM entity 210-k for use in computation of the relative trust value TV_{j,k}.

The relative trust value TV_{j,l} for the rental offer ROₗ may be computed by replacing the T_{j,k} in the equation (1) with T_{j,l} that denotes the trust assigned for the lending TM entity 210-l by the renting TM entity 210-j (while similar computation may be applied for computing the trust values for all other rental offers ROₓ possibly received by the renting TM entity 210-j).

The relative trust value TV_{j,k} may be applied in the renting TM entity 210-j to compute a comparison value S_{j,k} for the lending TM entity 210-k using, for example, the following equation:

$${S}_{j , k} = γ \cdot {TV}_{j , k} + δ \frac{1}{U {P}_{j , k}} , \qquad ( 2 )$$

where UP_{j,k} denotes the agreed unit price between the respective network operators operating the BBU subsystems 150-k and 150-j and γ and δ denote, respectively, predefined weighting factors assigned for contribution of the trust value TV_{j,k} and contribution of the unit price UP_{j,k} agreed for the rental between the renting and lending network operators. Typically, although not necessarily, the weighting factors γ and δ are defined such that γ+δ=1.

The comparison value S_{j,l} for the rental offer RO may be computed by replacing the TV_{j,k} in the equation (2) with TV_{j,l} that denotes the trust value TV_{j,l} computed for the lending TM entity 210-l by the renting TM entity 210-j (while similar computation of comparison value S_{j,x} may be applied for computing the trust values for all other rental offers ROₓ possibly received by the renting TM entity 210-j).

Once the respective comparison values S_{j,x} for all received rental offers ROₓ have been computed in the renting TM entity 210-j, it selects BBU subsystem 150-x for which the highest comparison value S_{j,x} has been derived as the actual lending TM entity. For editorial clarity of the description in this regard, in the following it is assumed that the lending TM entity 210-k has been selected as the actual lending TM entity.

In step 603, the renting TM entity 210-j transmits, to the selected lending TM entity 210-k, a preliminary request to implement the temporary provision of the radio access (i.e. the radio access rental) according the respective rental offer ROₖ by the lending BBU subsystem 150-k, as indicated in block 512. For the preliminary request, the renting TM entity 210-j computes a first signature Snⱼ=Sign(ROₖ, SKⱼ) as a signature on the rental offer ROₖ using a (predefined) private key SKⱼ of the renting TM entity 210-j. The first signature Snⱼ is included to the preliminary request transmitted from the renting TM entity 210-j to the lending TM entity 210-k. In an example, the first signature Snⱼ is computed according to the RSA algorithm using a procedure known in the art. In other examples, another technique known in the art for computing the signature may be employed. The preliminary request may further comprise one or more of the following: the rental offer ROₖ or one or more predefined pieces of information included therein, an identifier that identifies the renting network operator, an identifier that identifies the lending network operator.

The lending TM entity 210-k verifies the validity of the first signature Snⱼ received in the preliminary request. In an example, the verification is carried out using a (predefined) public key PKⱼ of the renting TM entity 210-j in accordance with the RSA algorithm using a procedure known in the art (or by using another suitable technique known in the art). In response to successful signature verification, in step 604 the lending TM entity 210-k responds to the preliminary request (of step 603) received from the renting TM entity 210-j by transmitting a confirmation to the renting TM entity 210-j, as indicated in block 514. For the confirmation, the lending TM entity 210-k computes a second signature Snₖ=Sign(Snⱼ, SKₖ) as a signature on the first signature Snⱼ received from the renting TM entity 210-j in the request using a (predefined) private key SKₖ of the lending TM entity 210-k. The second signature Snₖ is included to the confirmation transmitted from the lending TM entity 210-k to the renting TM entity 210-j. In an example, the second signature Snₖ is computed according to the RSA algorithm using a procedure known in the art. In other examples, another technique known in the art for computing the signature may be employed.

The renting TM entity 210-j verifies the validity of the second signature Snₖ received in the confirmation. In an example, the verification is carried out using a (predefined) public key PKⱼ of the lending TM entity 210-k in accordance with the RSA algorithm using a procedure known in the art (or by using another suitable technique known in the art). The verification of the second signature Snₖ received in the confirmation from the lending TM entity 210-k concludes the rental negotiation, and in response to successful signature verification, in step 605 the renting TM entity 210-j transmits to the lending TM entity 210-k an acknowledgement to implement the temporary provision of the radio access (i.e. the radio access resource rental) according the rental offer ROₖ by the lending BBU subsystem 150-k, as indicated in block 516. In response to receiving the acknowledgement, the lending TM entity 210-k takes necessary actions to implement the temporary provision (or re-location) of the radio access according to the rental offer ROₖ by the lending BBU subsystem 150-k (instead of the renting BBU subsystem 150-j), as indicated in block 518a. Moreover, as a further response to the confirmation received from the lending TM entity 210-k the renting TM entity 210-j re-directs radio access for one or more of its subscribers to take place via the BBU subsystem 150-k instead of the BBU subsystem 150-j according to the rental offer ROₖ, to implement the radio access rental, as indicated in block 518b.

During the radio access rental, the lending TM entity 210-k keeps track of information that is descriptive of the radio network usage by the subscribers of the renting network operator in the lending BBU subsystem 150-k. This tracking involves at least tracking of rental time rt and tracking of consumed radio access resources cr. The tracked information together with an indication of the agreed unit price UP_{j,k} between the respective network operators operating the BBU subsystems 150-k and 150-j is applied to generate a rental account RA. As an example, the rental account RA may be generated as a product RA=rt×cr×UP_{j,k}.

After the rental is completed, the lending TM entity 210 computes a third signature Sn_{RA}=Sign(RA, SKₖ) on the rental account RA using the private key SKₖ of the lending TM entity 210-k, and in step 606 the computed third signature Sn_{RA} is transmitted from the lending TM entity 210-k to the renting TM entity 210-j. Consequently, the renting TM entity 210-j computes a fourth signature Sn_{RA}′=Sign(Sn_{RA}, SKⱼ) on the third signature received from the lending TM entity 210-k using the private key SKⱼ of the renting TM entity 210-j, and in step 607 the computed fourth signature Sn_{RA} is transmitted from the TM entity 210-j to the lending TM entity 210-k. The fourth signature Sn_{RA}′, i.e. the rental account RA signed by both the lending TM entity 210-k and the renting TM entity 210-j, serves as the trust token for the respective rental of the radio access resources by the renting TM entity 210-j, which can be subsequently used by the lending network operator to claim the cost of the rental from the renting network operator or compensate its usage cost of resources in the future at the renting network operator. The third and fourth signatures may be computed (and verified), for example, in a similar manner as described in the following for the first and second signatures.

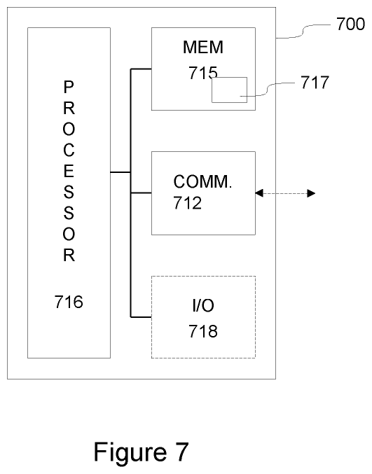

FIG. 7 illustrates a block diagram of some components of an exemplifying apparatus 700. The apparatus 700 may comprise further components, elements or portions that are not depicted in FIG. 7. The apparatus 700 may be employed in implementing e.g. a TM entity 210 of the trust management arrangement 200 or in implementing a BBU 110 of the C-RAN 100. In particular, the apparatus 700 may be employed as a sole device for implementing the TM entity 210 or the BBU 110, or two or more apparatuses 700 may be arranged to jointly implement the TM entity 210 or the BBU 110. For editorial clarity of description in this regard, in the following use of the apparatus 700 as a sole device for implementing the TM entity 210 is described.

The apparatus 700 comprises a communication portion 712 for communication with other devices. In particular, the communication portion 712 enables communication between two TM entities 210, between two BBUs, between a BBU 110 and a TM entity 210, between a BBU 110 and the core network 140 and/or between a TM entity 210 and the core network 140. In this regard, the communication portion 712 comprises at least one communication apparatus that enables wired communication with other apparatus, and the communication portion 712 may comprise one or more further (wireless or wired) communication apparatuses. A communication apparatus of the communication portion 712 may also be referred to as a respective communication means.

The apparatus 700 further comprises a processor 716 and a memory 715 for storing data and computer program code 717. The memory 715 and a portion of the computer program code 717 stored therein may be further arranged to, with the processor 716, to provide a control function for controlling operation of the apparatus and, in particular, cause the apparatus 700 to operate as the TM entity 210 or the BBU 110 as described in the foregoing. The memory 715 and a portion of the computer program code 717 stored therein may be further arranged to, with the processor 716, to provide a control function for controlling operation of a communication apparatus of the communication portion 712, possibly together with a control portion or a control function that may be provided within the respective communication apparatus of the communication portion 712. These control functions may be, separately or jointly, referred to as control means (of the apparatus 700).

The apparatus 700 may further comprise user I/O (input/output) components 718 that may be arranged, possibly together with the processor 716 and a portion of the computer program code 717, to provide a user interface for receiving input from a user of the first device 310 and/or providing output to the user of the accessory device 110. The user I/O components 718 may comprise hardware components such as a display, a touchscreen, a touchpad, a mouse, a keyboard, and/or an arrangement of one or more keys or buttons, etc. The user I/O components 718 may be also referred to as peripherals. The processor 716 may be arranged to control operation of the apparatus 700 e.g. in accordance with a portion of the computer program code 717 and possibly further in accordance with the user input received via the user I/O components 718 and/or in accordance with information received via the communication portion 712. Although the processor 716 is depicted as a single component, it may be implemented as r one or more separate processing components. Similarly, although the memory 715 is depicted as a single component, it may be implemented as one or more separate components, some or all of which may be integrated/removable and/or may provide permanent/semi-permanent/dynamic/cached storage.

The computer program code 717 stored in the memory 715, may comprise computer-executable instructions that control one or more aspects of operation of the apparatus 700 when loaded into the processor 716. As an example, the computer-executable instructions may be provided as one or more sequences of one or more instructions. The processor 716 is able to load and execute the computer program code 717 by reading the one or more sequences of one or more instructions included therein from the memory 715. The one or more sequences of one or more instructions may be configured to, when executed by the processor 716, cause the apparatus 700 to carry out operations, procedures and/or functions described in the foregoing in context of the TM entity 210 or the BBU 110. Hence, the apparatus 700 may comprise at least one processor 716 and at least one memory 715 including the computer program code 717 for one or more programs, the at least one memory 715 and the computer program code 717 configured to, with the at least one processor 716, cause the apparatus 700 to perform operations, procedures and/or functions described in the foregoing in context of the TM entity 210 or the BBU 110.

The computer programs stored in the memory 715 may be provided e.g. as a respective computer program product comprising at least one computer-readable non-transitory medium having the computer program code 717 stored thereon, the computer program code, when executed by the apparatus 700, causes the apparatus 700 at least to perform operations, procedures and/or functions described in the foregoing in context of the TM entity 210 or the BBU 110 in description of operation of the trust management arrangement 200. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

1-42. (canceled)

43. A method in a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network, the method comprising
transmitting a rental request to one or more further trust manager entities concerning a temporary usage of radio access managed by the virtual base station pool served by the respective further trust manager entity;
receiving, from one or more further trust manager entities, respective rental offers concerning the temporary usage of radio access managed by the virtual base station pool served by the respective further trust manager;
selecting one of the received rental offers in accordance with a predefined selection rule and selecting the source of the selected rental offer as a lending trust manager;
transmitting, to the lending trust manager entity, a preliminary request to implement the temporary usage of radio access according to the selected rental offer, wherein the preliminary request comprises a first signature that includes the selected rental offer signed using a private key of the first trust manager entity; and
transmitting, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.

44. A method in a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network, the method comprising
receiving, from a further trust manager entity, a rental request concerning temporary usage of radio access managed by the virtual base station pool served by the first trust manager entity;
generating a rental offer for the further trust manager entity in dependence of the rental request;
transmitting the generated rental offer to the further trust manager entity;
receiving, from the further trust manager entity, a preliminary request to implement the temporary usage of radio access according to said rental offer, wherein the preliminary request comprises a first signature that includes said rental offer signed using a private key of the further trust manager entity; and
transmitting, in response to said preliminary request, to the further trust manager entity, a confirmation that comprises a second signature that includes the first signature signed using a private key of the first trust manager entity.

45. An apparatus for operating as a first trust manager that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network, the apparatus comprising a communication portion comprising at least one communication apparatus for communication with other apparatuses and a control portion configured to, using the communication portion, cause the apparatus to
transmit a rental request to one or more further trust manager entities concerning a temporary usage of radio access managed by the virtual base station pool served by the respective further trust manager entity;
receive, from one or more further trust manager entities, respective rental offers concerning the temporary usage of radio access managed by the virtual base station pool served by the respective further trust manager;
select one of the received rental offers in accordance with a predefined selection rule and select the source of the selected rental offer as a lending trust manager;
transmit, to the lending trust manager entity, a preliminary request to implement the temporary usage of radio access according to the selected rental offer, wherein the preliminary request comprises a first signature that includes the selected rental offer signed using a private key of the first trust manager entity; and
transmit, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.

46. An apparatus according to claim 45, wherein the control portion is further configured to cause the apparatus to re-direct, after transmission of said acknowledgement, radio access for one or more subscribers of the first trust manager entity to take place via virtual base station pool served by the lending trust manager in accordance with the selected rental offer.

47. An apparatus according to claim 45, wherein the control portion is further configured to cause the apparatus to, after completion of temporary usage of radio access managed by the virtual base station pool served by the lending trust manager entity according to the selected rental offer, receive, from the lending trust manager entity, a third signature that includes a rental account generated by the lending trust manager entity signed using the private key of the lending trust manager entity; and
transmit, to the lending trust manager entity, a fourth signature that includes the third signature signed using the private key of the first trust manager entity.

48. An apparatus according to any of claim 45, wherein the rental request comprises at least one or more of the following:
amount of requested radio access resources,
an indication of a time period for which the radio access resources are requested, and a rental offer comprises an indication of a unit price for the temporary usage of radio access according to the rental request.

49. An apparatus according to claim 45, wherein selecting one of the received rental offers in accordance with a predefined selection rule comprises
computing a respective trust value for each of the one or more further trust manager entities from which a rental offer has been received in dependence of a first component that is descriptive of trust assigned for the respective further trust manager entity by the first trust manager entity and a second component that is descriptive of trust assigned for the respective further trust manager entity by one or more other further trust manager entities;
computing a respective comparison value for each of the received rental offers in dependence of a respective computed trust value and a unit price agreed between the first trust manager entity and the lending trust manager entity; and
selecting the rental offer for which the most favorable comparison value is computed.

50. An apparatus according to claim 49, wherein the trust value is computed as a weighted sum of the first component and the second component.

51. An apparatus according to claim 49, wherein the comparison value is computed as a weighted sum of the respective trust value and the inverse of said unit price.

52. An apparatus according to claim 45, wherein the control portion is further configured to, in order to carry out a trust attestation procedure with a further trust manager entity, cause the apparatus to
transmit a first challenge to said further trust manager entity;
verify a first certificate received from said further trust manager entity, which first certificate is a certificate of an execution environment of said further trust manager entity;
transmit, in response to successful verification of the first certificate, to the virtual base station pool served by said further trust manager entity, a second challenge;
verify a second certificate received from said virtual base station pool, which second certificate is a certificate of an execution environment of said virtual base station pool;
transmit, in response to successful verification of the second certificate, to said further trust manager entity, a trust policy pertaining to said further trust manager entity to enable said further trust manager entity and said virtual base station pool to monitor their respective compliance to said trust policy;
determine said virtual base station pool either as a trusted one or untrusted one in dependence of a response received from said further trust manager entity.

53. An apparatus according to claim 45, wherein the control portion is further configured to, in order to carry out a trust attestation procedure with a further trust manager entity, cause the apparatus to
transmit, to a further trust manager entity, in response to a first challenge received therefrom, a first certificate that is a certificate of an execution environment of the first trust manager entity;
monitor compliance of the first trust manager entity to a trust policy received from the further trust manager entity;
transmit said trust policy to the virtual base station pool served by the first trust manager entity for monitoring compliance to said trust policy therein;
transmit, to said further trust manager entity, a trust indication in dependence of the respective outcome of said monitoring operations in the first trust manager entity and in said virtual base station pool.

54. An apparatus according to claim 53, wherein said trust policy comprises one or more of the following:
a set of one or more reference hash codes that indicate valid hash codes for trust policy compliance monitoring,
a public key of a certificate issuer for verification of a certificate of the further trust manager entity.

55. An apparatus according to claim 54, wherein said monitoring comprises one or more of the following:
verifying that a hash code of the execution environment computed using a predefined hash function matches one of the reference hash codes received in the trust policy,
verifying the certificate of the further trust manager entity using said public key.

56. An apparatus according to claim 45, wherein the control portion is further configured to, in order to carry out a self-attestation procedure, cause the apparatus to
request, from a virtual base station pool served by the first trust manager entity, a hash code of the execution environment therein, computed using a predefined hash function;
compare the hash code received from said virtual base station pool to at least one reference hash code; and
determine successful self-attestation in response to the received hash code matching the at least one reference hash code.

57. An apparatus for operating as a first trust manager entity that is arranged to serve a virtual base station pool that manages usage of radio access for a baseband unit of a cloud radio access network within a trust management arrangement that comprises one or more further trust manager entities, each arranged to serve a respective virtual base station pool that manages usage of radio access for a respective further baseband unit of the cloud radio access network, the apparatus comprising a communication portion comprising at least one communication apparatus for communication with other apparatuses and a control portion configured to, using the communication portion, cause the apparatus to
receive, from a further trust manager entity, a rental request concerning temporary usage of radio access managed by the virtual base station pool served by the first trust manager entity;
generate a rental offer for the further trust manager entity in dependence of the rental request;
transmit the generated rental offer to the further trust manager entity;
receive, from the further trust manager entity, a preliminary request to implement the temporary usage of radio access according to said rental offer, wherein the preliminary request comprises a first signature that includes said rental offer signed using a private key of the further trust manager entity; and
transmit, in response to said preliminary request, to the further trust manager entity, a confirmation that comprises a second signature that includes the first signature signed using a private key of the first trust manager entity.

58. An apparatus according to claim 57, wherein the control portion is further configured to cause the apparatus to, after transmission of said confirmation,
receive, from the further trust manager entity transmitting, an acknowledgement to implement the temporary usage of radio access according to said rental offer; and
provide the radio access for one or more subscribers of the further trust manager entity according to said rental offer via the virtual base station pool served by the first trust manager.

59. An apparatus according to claim 57, wherein the control portion is further configured to cause the apparatus to,
during said temporary usage of radio access, keep track of information that is descriptive of radio access usage by said one or more subscribers of the further trust manager entity; and
after completion of said temporary usage of radio access, generate a rental account based on said tracked information and on a unit price agreed between the first trust manager entity and the further trust manager entity; and
transmit, to the further trust manager entity, a third signature that includes said rental account signed using the private key of the trust manager entity.

60. An apparatus according to claim 57, wherein the rental request comprises at least one or more of the following:
amount of requested radio access resources,
an indication of a time period for which the radio access resources are requested,
an indication of a unit price for the temporary usage of radio access according to the rental request.

61. An apparatus according to claim 60, wherein generating rental offer comprises generating the rental offer on basis of one or more of the following:
amount of unused radio access resources available for the virtual base station pool served by the first trust manager entity,
amount of requested radio access resources indication of a time period for which the radio access resources are requested,
relative priority assigned for said further trust manager entity,
a unit price defined for said rental offer,
estimated need for radio access resources in the virtual base station pool served by the first trust manager entity for its own subscribers.

62. A non-transitory computer readable medium comprising program instructions stored thereon for performing at least the following:
transmitting, by a first trust manager entity, a rental request to one or more further trust manager entities concerning a temporary usage of radio access managed by the virtual base station pool served by the respective further trust manager entity;
receiving, by the first trust manager entity, from one or more further trust manager entities, respective rental offers concerning the temporary usage of radio access managed by the virtual base station pool served by the respective further trust manager;
selecting, by the first trust manager entity, one of the received rental offers in accordance with a predefined selection rule and selecting the source of the selected rental offer as a lending trust manager;
transmitting, by the first trust manager entity, to the lending trust manager entity, a preliminary request to implement the temporary usage of radio access according to the selected rental offer, wherein the preliminary request comprises a first signature that includes the selected rental offer signed using a private key of the first trust manager entity; and
transmitting, by the first trust manager entity, to the lending trust manager entity, an acknowledgement to implement the temporary usage of radio access according to the selected rental offer in response to a confirmation received from the lending trust manager entity, wherein the confirmation comprises a second signature that includes the first signature signed using a private key of the lending trust manager entity.
